(19) United States
(12) Patent Application Publication
(10) Pub. No.: US 2021/0376515 A1
(43) Pub. Date: Dec. 2, 2021

(54) CLUSTER CONNECTOR ASSEMBLY AND METHOD FOR MOUNTING THE SAME

(71) Applicant: CommScope Technologies LLC, Hickory, NC (US)

(72) Inventors: Yuanyao Zhou, Suzhou (CN); Mulan Huang, Suzhou (CN); Jin Liu Liu, Suzhou (CN); Yujun Zhang, Suzhou (CN)

(21) Appl. No.: 17/313,385

(22) Filed: May 6, 2021

(30) Foreign Application Priority Data
May 29, 2020 (CN) 202010472376.8

(51) Int. Cl. H01R 13/42; H01R 13/512

(52) U.S. Cl. CPC H01R 13/42; H01R 13/512

(57) ABSTRACT

The present disclosure relates to a cluster connector assembly, wherein the cluster connector assembly comprises: a plurality of connectors with cables; a front case configured to integrate the connectors together; a locking assembly which can axially locks the connectors in the front case independently of each other; and a rear case which can be connected to the front case to fix the locking assembly. The cluster connector assembly is advantageous in that, each connector may be locked by a locking sleeve assigned uniquely for it, whereby the respective connectors can be locked reliably independent of each other. The present disclosure further relates to a method for mounting the cluster connector assembly.

### RELATED APPLICATION

The present application claims priority from and the benefit of Chinese Patent Application No. 202010472376.8, filed May 29, 2020, the disclosure of which is hereby incorporated herein in its entirety.

### FIELD OF THE INVENTION

The present disclosure relates to a cluster connector assembly and a method for mounting the same.

### BACKGROUND OF THE INVENTION

A cluster connector assembly typically includes a plurality of ports and allows a plurality of connectors to be mounted in an integrated manner, which greatly saves the mounting time and costs of the connectors. Thus, the cluster connector assembly may be applied more and more widely in 5G products.

FIG. 1a is an exploded view of a conventional cluster connector assembly 1′. The cluster connector assembly includes, from left to right, a front case 2′ with external threads, five connectors 5′ with cables 4′, a stopper 100, and a rear case 3′ with internal threads. In the mounted state of the cluster connector assembly 1′, the five connectors 5′ are abutted in five corresponding through holes 11′ of the front case 2′, respectively. The stopper 100 is clamped between the front case 2′ and the rear case 3′, with a left end surface of the stopper 100 being pressed against rear end surfaces of the five connectors 5′ to lock the respective connectors 5′, and with a right end surface thereof being supported in the rear case 3′.

FIG. 1b is an exploded view of another conventional cluster connector assembly 1″. Compared with the cluster connector assembly 1′ shown in FIG. 1a, the cluster connector assembly 1″ lacks the stopper 100, and edges of the rear end surfaces of the five connectors 5″ are directly supported in the rear case 3″.

In the cluster connector assemblies 1′, 1″ shown in FIGS. 1a and 1b, the plurality of connectors 5′, 5″ are axially locked at the same time either by means of a common stopper 100, or by direct use of the rear case 3″. This can be disadvantageous in that the rear end surfaces of the respective connectors 5′, 5″ may not be in the same plane in the mounted state due to manufacturing tolerances of corresponding components, so the stopper 100 or the rear case 3″ are unable to ensure all of the connectors 5′, 5″ to be reliably locked in the axial direction, and some of the connectors 5′, 5″ may still be slidable axially. Such axially sliding movement of the connectors 5′, 5″, even slightly, may negatively affect the performance of the entire connector assembly 1′, 1″.

Further, in the cluster connector assembly 1′ shown in FIG. 1a, the five cables 4′ are simultaneously restrained by the stopper 100 that is radially closed. If the connector 5′ or the cable 4′ at one port is damaged, the entire cluster connector assembly 1′ needs to be replaced.

Finally, in the cluster connector assembly 1′, 1″ shown in FIGS. 1a and 1b, as all the connectors 5′, 5″ are simultaneously fixed by a common stopper 100 or rear case 3″, the axial locking of the connector 5′, 5″ at each port cannot be adjusted separately. Therefore, once the cluster connector assembly 1′, 1″ has been mounted, the time-domain performance of the entire cluster connector assembly 1′, 1″ has been determined as well, and cannot be further optimized.

### SUMMARY

Thus, an object of the present disclosure is to provide a cluster connector assembly capable of overcoming at least one drawback in the prior art.

The first aspect of the present disclosure relates to a cluster connector assembly, wherein the cluster connector assembly comprises: a plurality of connectors with cables; a front case configured to integrate the connectors together; a locking assembly which can axially locks the connectors in the front case independently of each other; and a rear case which can be connected to the front case to fix the locking assembly.

In some embodiments, the locking assembly includes a plurality of locking sleeves and a locking disk with a corresponding plurality of through holes, the through holes each configured to receive a respective locking sleeve, wherein by cooperation of the locking disk with the locking sleeves, the connectors can be axially locked in the front case independently of each other.

In some embodiments, each of the through holes of the locking disk includes a hole section with internal threads, and each of the locking sleeves includes a threaded section with external threads, the internal threads being engageable with the external threads.

In some embodiments, each of the locking sleeves further includes a gripping section which can be grasped by fingers or a tool from outside of the cluster connector assembly in the mounted state.

In some embodiments, the gripping section of each of the locking sleeves has an outer diameter smaller than an inner diameter of a respective hole section with internal threads of the locking disk, so that the gripping section of each of the locking sleeves can pass freely through a respective hole section with internal threads of the locking disk.

In some embodiments, each of the locking sleeves further includes an abutment section for abutting against a respective connector.

In some embodiments, the threaded section of each of the locking sleeves is located between the abutment section and the gripping section.

In some embodiments, the abutment section of each of the locking sleeves includes a circumferential wall which can be fitted over part of circumferential surface of a respective connector, and a shoulder extending radially inward from an end of the circumferential wall close to the threaded section.

In some embodiments, the shoulder is configured to form a first shoulder surface for abutting against a rear end surface of the connector and a second shoulder surface facing the threaded section.

In some embodiments, each of the through holes of the locking disk further includes a hole section without threads, a stepped portion being formed between the hole section without threads and the hole section with internal threads, wherein a stepped surface of the stepped portion can abut against the second shoulder surface of the shoulder of a respective locking sleeve.

In some embodiments, said part of circumferential surface of the connector has a diameter equal to an inner diameter of the circumferential wall of the abutment section of the respective locking sleeve, and the remaining circumferential surface of the connector has a diameter equal to an outer diameter of the circumferential wall of the abutment section of the respective locking sleeve.

In some embodiments, each of the through holes of the locking disk is provided with a lateral notch extending from one end surface to the other end surface of the locking disk.

In some embodiments, the notch has a width smaller than widths of the cables, and the locking disk is made of elastic material.

In some embodiments, the notch has a width greater than or equal to widths of the cables.

In some embodiments, the locking disk is in the shape of a disk as a whole.

In some embodiments, the front case has through holes with stepped portions, wherein stepped surfaces of the stepped portions face the connectors and can be abutted against by front end surfaces of the connectors.

In some embodiments, the front case has a circumferential surface including a first circumferential surface section to be grasped and a second circumferential surface section for connection with the rear case.

In some embodiments, the front case and the rear case are in threaded connection with each other.

In some embodiments, the rear case is in the shape of a hollow cylinder as a whole.

In some embodiments, the rear case includes a connection section for connection with the front case, a receiving section adjacent to the connection section for receiving the locking disk, and a limiting section adjacent to the receiving section for axially limiting the locking disk.

In some embodiments, the connection section of the rear case has internal threads, and the rear case can be in threaded connection to the front case by means of these internal threads.

In some embodiments, the receiving section of the rear case is a continuation of the connection section.

In some embodiments, the receiving section of the rear case has an axial length substantially equal to a thickness of the locking disk.

In some embodiments, a stepped portion is formed between the limiting section and the receiving section of the rear case, a stepped surface of the stepped portion acting as a limiting surface for axially limiting the locking disk.

In some embodiments, a grasping portion is provided on the limiting section of the rear case along a circumferential direction for allowing the rear case to be grasped and screwed onto the front case.

In some embodiments, the locking assembly includes a plurality of locking sleeves each partially extending from the limiting section of the rear case to the outside in the mounted state.

The second aspect of the present disclosure relates to a method for mounting the cluster connector assembly discussed above, characterized in that the locking assembly includes a plurality of locking sleeves and a locking disk with a corresponding plurality of through holes, each of the locking sleeves being assigned to one connector and being screwed into one of the through holes of the locking disk, the method including:
fitting the locking sleeves and the through holes of the locking disk over cables of the connectors, with the locking sleeves being located between the connectors and the locking disk, and screwing the locking sleeves into the corresponding through holes of the locking disk until fully tightened;
inserting the connectors into the front case and moving the locking disk towards the connectors until the locking sleeves are abutted against the corresponding connectors;
fitting the rear case over the cables and connecting it to the front case, so that the locking disk is clamped by the front case and the rear case in both axial and radial directions; and
rotating the locking sleeves one by one, the threaded connections between the locking sleeves and the through holes of the locking disk transforming the rotational movements of the locking sleeves into linear movements thereof towards the connectors, so that the locking sleeves axially lock the corresponding connectors in the front case independently of each other.

Those skilled in the art will understand the advantages of corresponding embodiments and various additional embodiments by reading the following detailed description of the corresponding embodiments with reference to the drawings listed below.

### BRIEF DESCRIPTION OF THE DRAWINGS

The present disclosure will be further described in combination with the drawings and the embodiments.

FIG. 1a is an exploded perspective view of a cluster connector assembly in the prior art,

FIG. 1b is an exploded perspective view of another cluster connector assembly in the prior art,

FIG. 2a is a perspective view of a cluster connector assembly in the mounted state according to an embodiment of the present disclosure,

FIG. 2b is an exploded perspective view of the cluster connector assembly of FIG. 2a,

FIG. 3a is an exploded perspective view of the cluster connector assembly of FIGS. 2a and 2b, wherein only one connector is shown,

FIG. 3b is an exploded cut-away perspective view of the cluster connector assembly of FIG. 3a,

FIG. 3c is an exploded cut-away front view of the cluster connector assembly of FIG. 3a,

FIG. 4 is a perspective view of a locking disk according to the present disclosure,

FIGS. 5a and 5b are perspective views of a locking assembly in different states according to the present disclosure,

FIGS. 6a to 6f show different mounting steps of the cluster connector assembly according to the present disclosure, respectively.

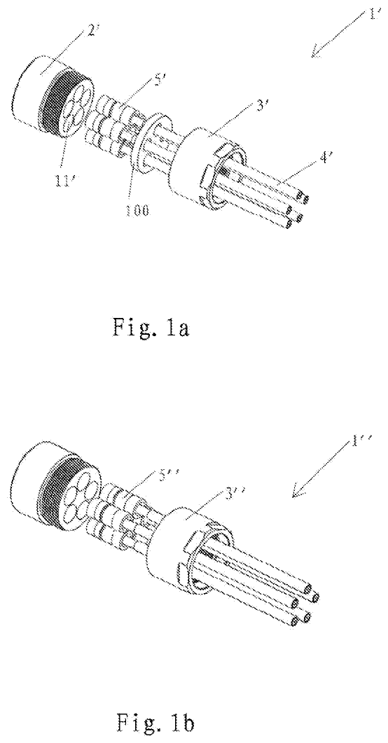

### EMBODIMENTS

The present disclosure will be described below with reference to the accompanying drawings, in which several embodiments of the present disclosure are shown. It should be understood, however, that the present disclosure may be presented in multiple different ways, and not limited to the embodiments described below. In fact, the embodiments described hereinafter are intended to make a more complete disclosure of the present disclosure and to adequately explain the protection scope of the present disclosure to a person skilled in the art. It should also be understood that, the embodiments disclosed herein can be combined in various ways to provide more additional embodiments.

It should be understood that, in all the accompanying drawings, the same reference signs present the same elements. In the drawings, for the sake of clarity, the sizes of certain features may be deformed.

It should be understood that, the wording in the specification is only used for describing particular embodiments and is not intended to define the present disclosure. All the terms used in the specification (including the technical terms and scientific terms), have the meanings as normally understood by a person skilled in the art, unless otherwise defined. For the sake of conciseness and/or clarity, the well-known functions or constructions may not be described in detail any longer.

The singular forms “a/an”, “said” and “the” as used in the specification, unless clearly indicated, all contain the plural forms. The wordings “comprising”, “containing” and “including” used in the specification indicate the presence of the claimed features, but do not repel the presence of one or more other features. The wording “and/or” as used in the specification includes any and all combinations of one or more of the relevant items listed. The phases “between X and Y” and “between about X and Y” as used in the specification should be construed as including X and Y. The phrase “between about X and Y” as used in the present specification means “between about X and about Y”, and the phrase “from about X to Y” as used in the present specification means “from about X to about Y”.

In the specification, when one element is referred to as being “on” another element, “attached to” another element, “connected to” another element, “coupled to” another element, or “in contact with” another element, the element may be directly located on another element, attached to another element, connected to another element, coupled to another element, or in contact with another element, or there may be present with an intermediate element. By contrast, where one element is referred to as being “directly” on another element, “directly attached to” another element, “directly connected to” another element, “directly coupled to” another element, or “in direct contact with” another element, there will not be present with an intermediate element. In the specification, where one feature is arranged to be “adjacent” to another feature, it may mean that one feature has a portion that overlaps with an adjacent feature or a portion that is located above or below an adjacent feature.

In the specification, the spatial relation wordings such as “up”, “down”, “left”, “right”, “forth”, “back”, “high”, “low” and the like may describe a relation of one feature with another feature in the drawings. It should be understood that, the spatial relation wordings also contain different orientations of the apparatus in use or operation, in addition to containing the orientations shown in the drawings. For example, when the apparatus in the drawings is overturned, the features previously described as “below” other features may be described to be “above” other features at this time. The apparatus may also be otherwisely oriented (rotated 90 degrees or at other orientations). At this time, the relative spatial relations will be explained correspondingly.

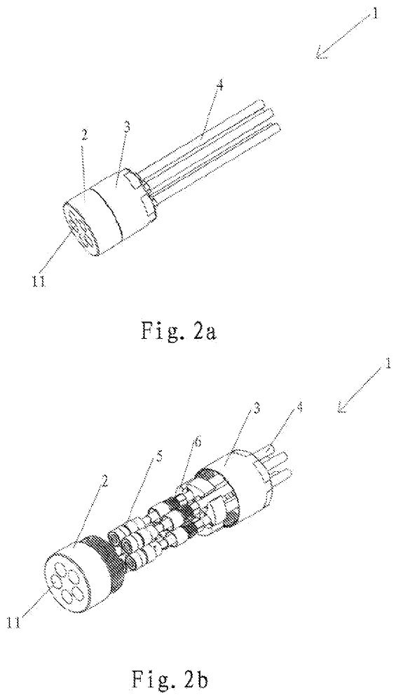

One embodiment of the cluster connector assembly 1 according to the present disclosure is generally described with reference to FIGS. 2a and 2b, in which FIG. 2a is a perspective view of the cluster connector assembly 1 according to the present disclosure in the mounted state, and FIG. 2b is a perspective view of the cluster connector assembly 1 in the exploded state. As can be seen from FIGS. 2a and 2b, the cluster connector assembly 1 of the present disclosure may include a front case 2, a rear case 3, and a plurality of (shown as five in the figures as an example) connectors 5 with cables 4 fixed between the front case 2 and the rear case 3. In the mounted state of the cluster connector assembly 1, the connectors 5 may be inserted in and abutted against corresponding through holes 11 of the front case 2 respectively. The cluster connector assembly 1 according to the present disclosure may further include a locking assembly 6 for axially locking the respective connectors 5. The locking assembly 6 includes locking sleeves 20 and a locking disk 28, which will be described in detail below.

In the figures, in view of the cylindrical shapes of the front case 2 and the rear case 3, the cluster connector assembly 1 may be in the shape of a cylinder as an entirety. In some embodiments, the cluster connector assembly 1 may also be in the shape of a cube, a cuboid, a prism, or the like as an entirety, and the front case 2 and the rear case 3 may accordingly be in the shape of a cube, a cuboid, a prism, or the like.

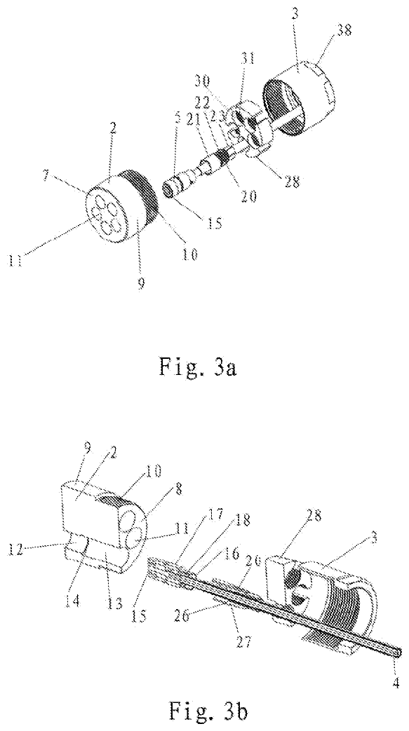

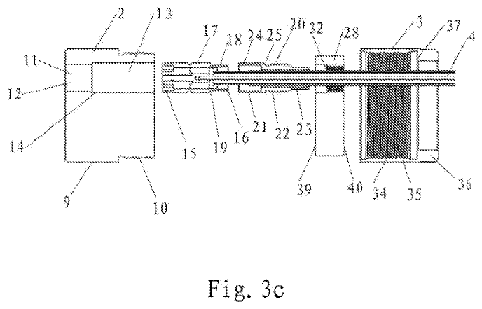

FIGS. 3a to 3c are an exploded perspective view, an exploded cut-away perspective view, and an exploded cut-away front view of the cluster connector assembly 1, respectively. For the purpose of clarity, only one connector 5 and its cable 4 are shown. The individual components of the cluster connector assembly 1 together with their cooperation relationship will be described in detail below from front to back with reference to FIGS. 3a to 3c.

The front case 2 of the cluster connector assembly 1 is substantially in the shape of a solid cylinder. The front case 2 may include a front end surface 7 (i.e., a left end surface in the figures), a rear end surface 8 (i.e., a right end surface in the figures), and a circumferential wall extending between the front end surface 7 and the rear end surface 8. The circumferential wall includes a first circumferential surface section 9 close to the front end surface 7, and a second circumferential surface section 10 close to the rear end surface 8. The second circumferential surface section 10 of the front case 2 may be provided with external threads, which may engage with internal threads of the rear case 3 to be described below. The first circumferential surface section 9 of the front case 2 may not be provided with external threads. The first circumferential surface section 9 of the front case 2 is allowed to be grasped by fingers upon mounting, and thus may be roughened to facilitate firm grasping.

The front case 2 may have a plurality of (shown as five in the figures) through holes 11 each extending between the front end surface 7 and the rear end surface 8 and parallel to a longitudinal axis of the front case 2. Each through hole 11 may receive one of the connectors 5. The through holes 11 may be in an annular arrangement about the longitudinal axis of the front case 2. In some embodiments, the number of the through holes 11 in the front case 2 may be four, eight, or the like, depending on the number of the connectors 5 to be received. These through holes 11 may be distributed in rows, in a circle or in a honeycomb shape. Referring to FIGS. 3b and 3c, each through hole 11 may include a first hole section 12 close to the front end surface 7 of the front case 2, and a second hole section 13 close to the rear end surface 8 of the front case 2. The first hole section 12 may have an inner diameter smaller than that of the second hole section 13, so that a transition between the two hole sections 12, 13 may be formed into a stepped portion 14, which may have a stepped surface facing the rear end surface 8 of the front case 2.

Each connector 5 of the cluster connector assembly 1 may include a front end surface 15 (i.e., a left end face in the figures), a rear end surface 16 (i.e., a right end surface in the figures), and a circumferential wall extending between the front end surface 15 and the rear end surface 16. The circumferential wall of each connector 5 includes a first circumferential surface section 17 near the front end surface 15 of the connector, and a second circumferential surface section 18 near the rear end surface 16 of the connector. The first circumferential surface section 17 of each connector 5 may have a diameter greater than that of the second circumferential surface section 18, so that a transition therebetween may be formed into a stepped portion 19, which may have a stepped surface facing the rear end surface 16 of the connector 5. Each connector 5 may also include a central through hole for insertion of the cable 4.

In a state where the connectors 5 are mounted in the through holes 11 of the front case 2, the front end surfaces 15 of the connectors 5 may be abutted against the stepped surfaces of the through holes 11 in the front case 2, and the first circumferential surface sections 17 of the connectors 5 may be radially limited by circumferential surfaces of the second hole sections 13 of the through holes 11 in the front case 2.

As mentioned above, the locking assembly 6 is configured to lock the connectors 5. The locking sleeves 20 of the locking assembly 6 are substantially in the shape of hollow cylinders. Each locking sleeve 20 may include, from left to right, an abutment section 21 for abutting against a respective connector 5, a threaded section 22 with external threads, and a gripping section 23 for being grasped by fingers or a tool.

The abutment section 21 of each locking sleeve 20 may include a circumferential wall 24 parallel to a longitudinal direction of the cables 4, and a shoulder 25 extending radially inward from an end of the circumferential wall 24 close to the threaded section 22. The shoulder 25 may be configured to include a first shoulder surface 26 facing the respective connector 5, and a second shoulder surface 27 facing the threaded section 22. The circumferential wall 24 of the abutment section 21 may have an inner diameter equal to the diameter of the second circumferential surface section 18 of the respective connector 5, so that the abutment section 21 of each locking sleeve 20 may be fitted over the second circumferential surface section 18 of the respective connector 5. The circumferential wall 24 of the abutment section 21 may have an axial length equal to that of the second circumferential surface section 18 of the respective connector 5, so that the front end surface (i.e., the left end surface) of the circumferential wall 24 of the abutment section 21 may be abutted against the stepped surface 19 of the respective connector 5, and meantime the rear end surface 16 of the respective connector 5 may be abutted against the first shoulder surface 26 of the abutment section 21. This can ensure optimal transmission of the axial locking force from each locking sleeve 20 to the respective connector 5. The circumferential wall 24 of the abutment section 21 may have an outer diameter equal to the diameter of the first circumferential surface section 17 of the respective connector 5, so that the circumferential wall 24 of the abutment section 21 may be inserted, along with the respective connector 5, at least partially into the second hole section 13 of the respective through hole 11 in the front case 2, thereby increasing the compactness of the cluster connector assembly 1.

The threaded sections 22 of the locking sleeves 20 may be adjacent to the shoulders 25 of the abutment sections 21. Each threaded section 22 may have an outer diameter smaller than that of the abutment section 21, and may be provided with external threads for engagement with internal threads of the locking disk 28 to be described in detail later.

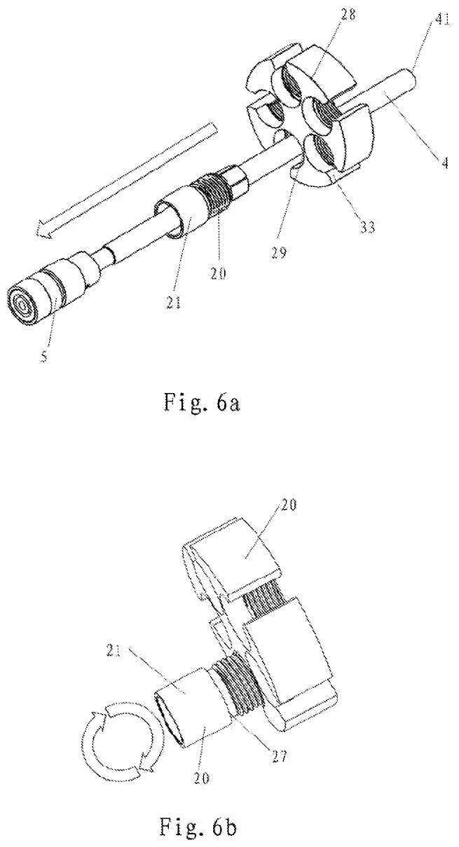

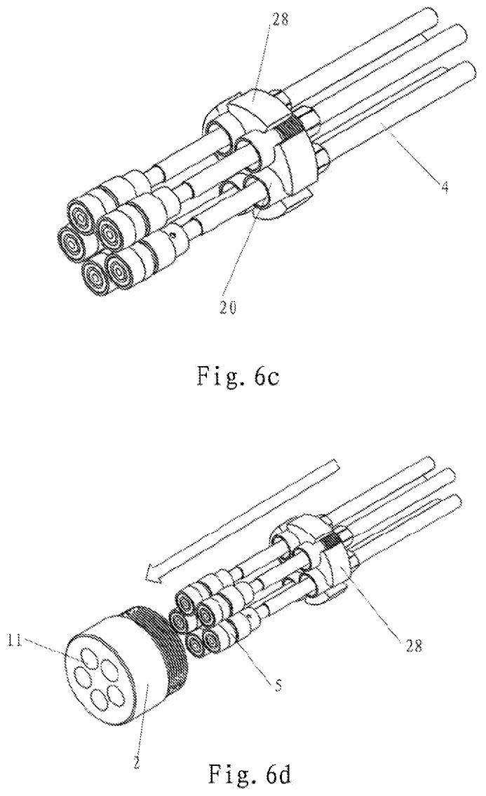

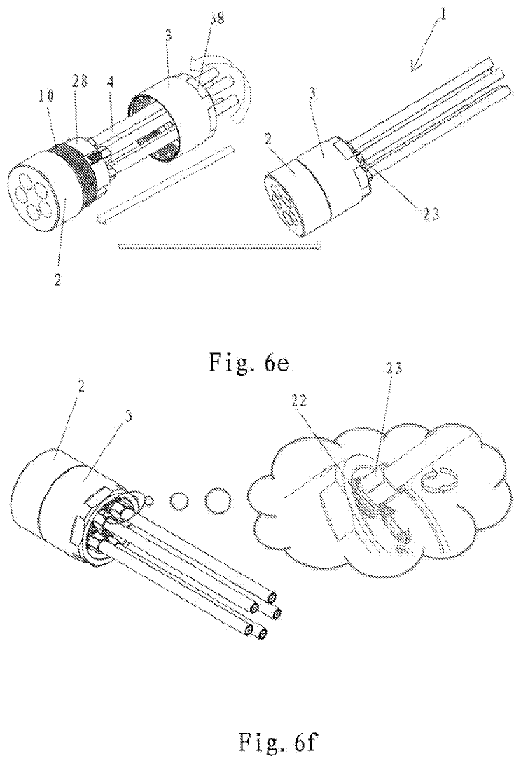

The gripping sections 23 of the locking sleeves 20 may be adjacent to the threaded sections 22. The gripping sections 23 may be in the shape of a polyhedron (for example, a hexahedron) to facilitate being grasped and rotated by fingers or a tool. Each gripping section 23 may have a sufficient axial length, such that after mounting of the cluster connector assembly 1, the gripping section 23 may be exposed from the bottom of the rear case 3 by a sufficient length for being grasped (refer to FIG. 6f). The gripping section 23 of each locking sleeve 20 may have a diameter smaller than that of the threaded section 22 so as to be able to pass through the respective through hole of the locking disk 28 without interference.

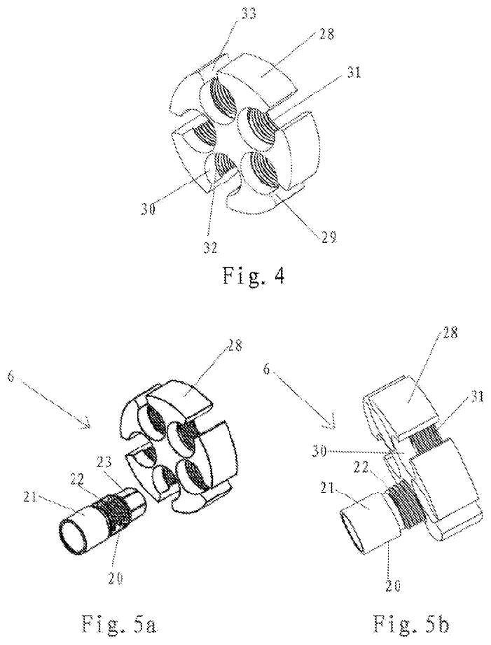

Referring to FIGS. 3a to 3c and FIG. 4, the locking disk 28 of the cluster connector assembly 1 may be, as an entirety, in the shape of a disk with certain thickness. The locking disk 28 may have a plurality of through holes 29, the number and arrangement of which are consistent with those of the through holes 11 in the front case 2. Each through hole 29 of the locking disk 28 may receive one of the locking sleeves 20.

Each through hole 29 of the locking disk 28 may include a first hole section 30 without threads close to the respective connector 5, and a second hole section 31 with internal threads away from the respective connector 5. In some embodiments, each entire through hole 29 of the locking disk 28 may be provided with internal threads. The first hole section 30 may have an inner diameter larger than that of the second hole section 31 so that a stepped portion 32 is formed between the two hole sections 30 and 31, the stepped surface of which stepped portion 32 may face the respective connector 5. Owing to their small outer diameters, the gripping sections 23 of the locking sleeves 20 are able to pass freely through the entire through holes 29 of the locking disk 28. The threaded sections 22 of the locking sleeves 20 may pass freely through the first hole sections 30 of the locking disk 28 and then be screwed into the second hole sections 31 of the locking disk 28. The outer diameters of the abutment sections 21 of the locking sleeves 20 may be equal to the inner diameters of the first hole sections 30 of the locking disk 28, so that the abutment sections 21 of the locking sleeves 20 may be partially received in the first hole sections 30 of the locking disk 28, and may be abutted, with their second shoulder surfaces 27, against the stepped surfaces of the through holes 29 of the locking disk 28.

Referring to FIG. 4, the through holes 29 of the locking disk 28 may not be closed in their radial directions, that is, the locking disk 28 may be provided, along its circumferential edge, with notches or openings 33 each extending from one end surface to the other end surface of the locking disk 28. The notches 33 may have widths smaller than the diameters of the cables 4 so as to prevent the cables 4 in the through holes 29 from accidentally moving laterally out of the notches 33. In this case, the locking disk 28 may be elastic, so that the cables 4 are capable of being pressed or drawn laterally into or out of the through holes 29 of the locking disk 28. In some embodiments, the widths of the notches 33 may be equal to or greater than the diameters of the cables 4, in which case the locking disk 28 is not required to be elastic. The arrangement of the notches 33 for the through holes 29 is advantageous in that any portion of the cables 4 can be pressed into or drawn out of the through holes 29 laterally of the locking disk 28 without having to fit the locking disk 28 over the cables 4 from tail ends 41 of the cables 4. Firstly, this can greatly simplify mounting for the instance where a plurality of the cables 4 need to be packed in a single locking disk 28. In addition, when one of the connectors 5 or cables 4 is damaged, it is convenient to dismount only the damaged connector 5 together with its cable 4 without replacing the entire cluster connector assembly 1.

In the mounted state, the front end surface of the locking disk 28 facing the front case 2 may be abutted against the rear end surface 8 of the front case 2, and the through holes 29 of the locking disk 28 may be aligned with the through holes 11 of the front case 2.

The rear case 3 of the cluster connector assembly 1 may be substantially in the shape of a hollow cylinder as a whole. The rear case 3 has a circumferential wall surrounding its central through hole. The rear case 3 may include, from left to right, a connection section 34 for connection with the front case 2, a receiving section 35 adjacent to the connection section 34 for receiving the locking disk 28, and a limiting section 36 adjacent to the receiving section 35 for axially limiting the locking disk 28.

The connection section 34 of the rear case 3 may be provided, on an inner surface of the circumferential wall, with internal threads for engagement with the external threads on the second circumferential surface section 10 of the front case 2. The rear case 3 may be in threaded connection to the front case 2 by means of these internal threads.

The receiving section 35 of the rear case 3 may be a continuation of the connection section 34 and thus have threads as well, or it may be a separate section without threads. Nevertheless, it may be desirable that the receiving section 35 is capable of radially limiting the locking disk 28. The receiving section 35 of the rear case 3 may have an inner diameter equal to the outer diameter of the locking disk 28, and an axial length substantially equal to a thickness of the locking disk 28.

The limiting section 36 of the rear case 3 may be a flange protruding radially inward from the circumferential wall, and an inner diameter of the flange may be smaller than the inner diameter of the receiving section 35, so that a transition between the two sections may be formed into a stepped portion 37, the stepped surface of which may face the locking disk 28 and thus functions as a limiting surface for axially limiting the locking disk 28. A grasping portion 38 may be provided on an outer surface of the limiting section 36 of the rear case 3 in the circumferential direction, whereby the rear case 3 can be easily grasped and screwed onto the front case 2. The grasping portion 38 may be a plurality of flat portions or curved portions fabricated on the limiting section 36 in the circumferential direction.

In a state where the rear case 3 is screwed onto the front case 2, the front end surface 39 of the locking disk 28 may be abutted against the rear end surface 8 of the front case 2, and the rear end surface 40 of the locking disk 28 may abut on the stepped surface of the limiting section 36 of the rear case 3, so that the locking disk 28 may be axially limited by the front case 2 and the rear case 3. In this way, the locking disk 28 may be firmly fixed inside the cluster connector assembly 1. At this time, the circumferential surface of the rear case 3 may be flush with the first circumferential surface section 9 of the front case 2.

FIGS. 5a and 5b illustrate the locking assembly 6 according to the present disclosure, respectively. The locking assembly 6 may include the locking disk 28 as described above, and a plurality of the locking sleeves 20 each cooperating with the locking disk 28. For the sake of clarity, only one locking sleeve 20 is shown in the figures. In FIG. 5a, the locking sleeve 20 is about to be screwed into the locking disk 28, while in FIG. 5b, the locking sleeve 20 has been partially screwed into the locking disk 28.

Each connector 5 may be assigned with one locking sleeve 20 and one through hole 29 of the locking disk 28. By cooperation of the locking disk 28 with the respective locking sleeves 20, the connectors 5 are capable of being locked or released in the axial direction independently of each other.

Here, “independent of each other” means that when one of the connectors 5 is locked or released, the tightening state of the other connectors 5 may not be affected.

In the mounted state of the cluster connector assembly, the locking sleeves 20 are in threaded connections with the through holes 29 of the locking disk 28. When the connectors 5 are to be further locked, the gripping sections 23 of the locking sleeves 20 are grasped with fingers or a tool, and the locking sleeves 20 are rotated to make the locking sleeves 20 moved towards and press the connector 5 until the front end surfaces 15 of the connectors 5 are locked to the stepped surfaces of the through holes 11 of the front case 2. On the contrary, when the connectors 5 are to be released, the gripping sections 23 of the locking sleeves 20 are grasped with fingers or a tool, and the locking sleeves 20 are rotated in the opposite direction to move the locking sleeves 20 away from the connectors 5 to release the connectors 5.

Therefore, the cooperation of the locking disk 28 with the locking sleeves 20 means that, in the case where the locking disk 28 is fixed in position by the front case 2 and the rear case 3, based on the threaded connections between the locking sleeves 20 and the through holes 29 of the locking disk 28, the rotational movements of the locking sleeves 20 may be transformed into a translational movements of the locking sleeves 20 towards the corresponding connectors 5 to thereby lock the connectors 5.

Next, the mounting steps of the cluster connector assembly 1 according to the present disclosure will be described with reference to FIGS. 6a to 6f. In the figures, the cluster connector assembly 1 with five ports is taken as an example, but this mounting method is also applicable to the cluster connector assembly 1 with another number, such as four, eight or the like, of ports.

Referring to FIG. 6a, one of the locking sleeves 20 is fitted over a cable 4 from the tail end 41 of the cable 4 with the abutment section 21 of the locking sleeve 20 facing the connector 5. Then, one of the through holes 29 of the locking disk 28 is fitted over the cable 4 from the tail end 41 of the cable 4, or the cable 4 is pressed radially into one of the through holes 29 of the locking disk 28 through one notch 33 of the locking disk 28. At this time, the locking sleeve 20 is located between the connector 5 and the locking disk 28.

Referring to FIG. 6b, the locking sleeve 20 is screwed into the corresponding through hole 29 of the locking disk 28 until it is completely tightened, that is, until the shoulder 25 of the abutment section 21 of the locking sleeve 20 is abutted, with its second shoulder surface 27, against the stepped surface of the through hole 29 of the locking disk 28.

Referring to FIG. 6c, the above steps are repeated until five locking sleeves 20 are all fitted over the corresponding cables 4 and are all screwed tightly in the five corresponding through holes 29 of the locking disk 28.

Referring to FIG. 6d, the five connectors 5 are inserted into second hole sections 13 of five corresponding through holes 11 of the front case 2, respectively, and the locking disk 28 is moved towards the connectors 5, so that the locking sleeves 20 therein are abutted against the corresponding connectors 5 respectively, that is, the abutment sections 21 of the locking sleeves 20 are fitted over the second circumferential surfaces of the connectors 5.

Referring to FIG. 6e, the rear case 3 is fitted over the cables 4 from the tail ends 41 of the cables 4 and is screwed onto the second circumferential surface section 10 of the front case 2 with its internal threads by means of its grasping section 38. As a result, the locking disk 28 is clamped by the front case 2 and the rear case 3 in both axial and radial directions, with the gripping sections 23 of the respective locking sleeves 20 being exposed to the external environment from the bottom of the rear case 3 to be available by fingers or tools. In this way, pre-assembly and pre-tightening of the connectors 5 in the through holes 11 of the front case 2 are finished.

Referring to FIG. 6f, the gripping sections 23 of the locking sleeves 20 are grasped and rotated individually with fingers or a tool. Based on the cooperation of the external threads of the locking sleeves 20 with the internal threads of the locking disk 28, the rotational movements of the locking sleeves 20 are transformed into linear movements of the locking sleeves 20 towards the corresponding connectors 5, thereby further axially locking the connectors 5 in the through holes 11 of the front case 2 independently of each other. This fulfills separate axial locking of each connector 5 in the front case 2.

Thus, the outer sections of the through holes of the connectors 5 may be used for connections with connectors (not shown) of the base station antenna, which are inserted into the through holes 11 of the front case 2 from the outside and gets connections with the connectors 11.

The cluster connector assembly 1 according to the present disclosure is advantageous in that, each connector 5 may be locked by a locking sleeve 20 assigned uniquely for it, whereby the respective connectors 5 can be locked reliably independent of each other. Compared with the unified fixing by a common component in the prior art (which is negatively affected by the manufacturing tolerance of corresponding components), the locking of each connector in the present disclosure can be performed separately, which greatly reduces the sensitivity of locking effect to manufacturing tolerances of the components.

Further, with respect to the cluster connector assembly 1 according to the present disclosure, if the connector 5 or cable 4 at one port is damaged, it can be replaced conveniently and separately without replacing the entire cluster connector assembly 1, thereby reducing maintenance costs.

Finally, the connectors 5 in the cluster connector assembly 1 of the present disclosure can be separately adjusted axially, so the electrical length of the connectors can also be adjusted separately, making it possible to achieve the optimal time-domain performance of the entire cluster connector assembly 1.

Although the exemplary embodiments of the present disclosure have been described, a person skilled in the art should understand that, he or she may make multiple changes and modifications to the exemplary embodiments of the present disclosure without substantively departing from the spirit and scope of the present disclosure. Accordingly, all the changes and modifications are encompassed within the protection scope of the present disclosure as defined by the claims.

What is claimed is:

1. A cluster connector assembly, characterized in that the cluster connector assembly comprises:
a plurality of connectors with cables;
a front case configured to integrate the connectors together;
a locking assembly which can axially locks the connectors in the front case independently of each other; and
a rear case which can be connected to the front case to fix the locking assembly.

2. The cluster connector assembly according to claim 1, characterized in that the locking assembly includes a plurality of locking sleeves and a locking disk with a corresponding plurality of through holes, the through holes each configured to receive a respective locking sleeve, wherein by cooperation of the locking disk with the locking sleeves, the connectors can be axially locked in the front case independently of each other.

3. The cluster connector assembly according to claim 2, characterized in that each of the through holes of the locking disk includes a hole section with internal threads, and each of the locking sleeves includes a threaded section with external threads, the internal threads being engageable with the external threads.

4. The cluster connector assembly according to claim 3, characterized in that each of the locking sleeves further includes a gripping section which can be grasped by fingers or a tool from outside of the cluster connector assembly in the mounted state.

5. The cluster connector assembly according to claim 4, characterized in that the gripping section of each of the locking sleeves has an outer diameter smaller than an inner diameter of a respective hole section with internal threads of the locking disk, so that the gripping section of each of the locking sleeves can pass freely through a respective hole section with internal threads of the locking disk.

6. The cluster connector assembly according to claim 2, characterized in that each of the through holes of the locking disk is provided with a lateral notch extending from one end surface to the other end surface of the locking disk.

7. The cluster connector assembly according to claim 6, characterized in that the notch has a width smaller than widths of the cables, and the locking disk is made of elastic material.

8. The cluster connector assembly according to claim 6, characterized in that the notch has a width greater than or equal to widths of the cables.

9. The cluster connector assembly according to claim 2, characterized in that the locking disk is in the shape of a disk as a whole.

10. The cluster connector assembly according to claim 1, characterized in that the front case has through holes with stepped portions, wherein stepped surfaces of the stepped portions face the connectors and can be abutted against by front end surfaces of the connectors.

11. The cluster connector assembly according to claim 1, characterized in that the front case has a circumferential surface including a first circumferential surface section to be grasped and a second circumferential surface section for connection with the rear case.

12. The cluster connector assembly according to claim 11, characterized in that the front case and the rear case are in threaded connection with each other.

13. The cluster connector assembly according to claim 1, characterized in that the rear case is in the shape of a hollow cylinder as a whole.

14. The cluster connector assembly according to claim 1, characterized in that the rear case includes a connection section for connection with the front case, a receiving section adjacent to the connection section for receiving the locking disk, and a limiting section adjacent to the receiving section for axially limiting the locking disk.

15. The cluster connector assembly according to claim 14, characterized in that the receiving section of the rear case is a continuation of the connection section.

16. The cluster connector assembly according to claim 14, characterized in that the receiving section of the rear case has an axial length substantially equal to a thickness of the locking disk.

17. The cluster connector assembly according to claim 14, characterized in that a stepped portion is formed between the limiting section and the receiving section of the rear case, a stepped surface of the stepped portion acting as a limiting surface for axially limiting the locking disk.

18. The cluster connector assembly according to claim 14, characterized in that a grasping portion is provided on the limiting section of the rear case along a circumferential direction for allowing the rear case to be grasped and screwed onto the front case.

19. The cluster connector assembly according to claim 14, characterized in that the locking assembly includes a plurality of locking sleeves each partially extending from the limiting section of the rear case to the outside in the mounted state.

20. A method for mounting a cluster connector assembly, comprising;
providing a cluster connector assembly comprising: a plurality of connectors with cables; a front case configured to integrate the connectors together; a locking assembly which can axially locks the connectors in the front case independently of each other; and a rear case which can be connected to the front case to fix the locking assembly, wherein the locking assembly includes a plurality of locking sleeves and a locking disk with a corresponding plurality of through holes, each of the locking sleeves being assigned to one connector and being screwed into one of the through holes of the locking disk, the method including:
fitting the locking sleeves and the through holes of the locking disk over cables of the connectors, with the locking sleeves being located between the connectors and the locking disk, and screwing the locking sleeves into the corresponding through holes of the locking disk until fully tightened;
inserting the connectors into the front case and moving the locking disk towards the connectors until the locking sleeves are abutted against the corresponding connectors;
fitting the rear case over the cables and connecting it to the front case, so that the locking disk is clamped by the front case and the rear case in both axial and radial directions; and
rotating the locking sleeves one by one, the threaded connections between the locking sleeves and the through holes of the locking disk transforming the rotational movements of the locking sleeves into linear movements thereof towards the connectors, so that the locking sleeves axially lock the corresponding connectors in the front case independently of each other.
